(19) United States
(12) Patent Application Publication
(10) Pub. No.: US 2009/0195377 A1
(43) Pub. Date: Aug. 6, 2009

(54) DRIVING MODULE WITH BIDIRECTIONAL LENSES AND SCREEN FOR DISPLAYING IMAGES

(76) Inventor: Ching-Shan Chang, Taiwan (CN)

Correspondence Address: J C PATENTS, INC., 4 VENTURE, SUITE 250, IRVINE, CA, 92618, US

(21) Appl. No.: 11/571,227

(22) PCT Filed: Mar. 1, 2006
(86) PCT No.: PCT/CN06/00298

§ 371 Date: Jul. 19, 2007

(30) Foreign Application Priority Data
Jan. 13, 2006 (CN) 200610001604.3

(51) Int. Cl. B60Q 1/00; H04N 5/00; G02B 13/16

(52) U.S. Cl. 340/461; 340/425.5; 386/125; 348/335; 348/E05.024

(57) ABSTRACT

A driving module with bidirectional lenses and screen for displaying images includes a body, an image capturing unit and an image displaying unit, wherein the image capturing unit is disposed in the body and has a first lens and a second lens disposed and exposed on the body, wherein the first lens is adopted for capturing the images from a first direction and the second lens is adopted for catching the images from a second direction. In addition, the image displaying unit is disposed in the body and has a display for playing back the images captured by the first lens and/or images captured by the second lens.

### BACKGROUND OF THE INVENTION

1. Field of the Invention

The present invention relates to a vehicle apparatus, and more particularly to a vehicle apparatus with video recording and playback functions.

2. Description of the Related Art

Automobiles are indispensable and popular transportation means in modern life. Along with the advanced technology progress, a vehicle is equipped with a variety of accessories to meet driver's demands, such as a video equipment, a speed measuring radar and a GPS (global positioning system) to provide a driver with the required information.

For driving safely, a driver must keep focus on road conditions all time during driving. However, the audio-optical signals produced by various accessories tend to distract the driver from paying attention to road situations, which may be very dangerous. On the other hand, during operation of the above-described accessories, it is likely to withdraw driver's focus from the driving direction, which is very dangerous for the driver and the vehicle. Thus, how to improve the abovementioned problem is an important issue for the manufacturers/researchers in the field.

In addition, a vehicle condition itself may have direct influence to safe driving. Normally a driver only gets a limited information from indicators of the instrument cluster, which restricts the driver from knowing more detail situations of the vehicle and the driver is not sure whether or not a specific part needs to be replaced or maintained.

### SUMMARY OF THE INVENTION

An object of the present invention is to provide a driving module with bidirectional lenses and screen for displaying images, which integrates other related accessories of a vehicle to help to driver's operation for promoting safe driving conditions. On the other hand, by linking the driving module with bidirectional lenses and screen for displaying images with the vehicle via a data link connector (DLC), it is possible to upload or store any data from/into an on board diagnostics system (OBD), and thereby monitor the running conditions of the whole vehicle, such as engine speed, vehicle speed, coolant temperature, load, airflow volume, feedback threshold value, monitoring and testing data with an oxygen sensor, memorized computer code information, catalytic converter condition and heating function thereof, misfire monitoring situation, evaporation control system (ECS) situation, air injection system (AIS) situation, fuel system situation, monitoring situation with an oxygen sensor, EGR situation (exhaust gas recirculation system), PCV situation (positive crankcase ventilation system) and other information related to exhaust emission control components. Accordingly, the driving module with bidirectional lenses and screen for displaying images of the present invention is a valuable not only to monitor the whole running conditions of the vehicle and to get information about fuel consumption, EGR monitoring and memorized computer codes, but also substantially reduce the vehicle maintenance cost.

To achieve the above-described or other objects, the present invention provides a driving module with bidirectional lenses and screen for displaying images, which includes a body, an image capturing unit and an image displaying unit. Wherein, the body is disposed in the interior of the vehicle. The image capturing unit is disposed in the body and has a first lens and a second lens both disposed and exposed on the body. The first lens is adopted for capturing images from a first direction and the second lens is adopted for capturing images from a second direction. The above-described image displaying unit is disposed in the body and has a display for playing back the images captured by the first lens and/or the images captured by the second lens.

In an embodiment of the present invention, the above-described driving module with bidirectional lenses and screen for displaying images further includes a data storage unit disposed in the body. The data storage unit has a built-in memory and a hard disk, wherein the built-in memory is adopted for storing an image capturing program and/or a image displaying program, the image capturing program may direct the first lens and/or the second lens to capture images and store the captured images into the hard disk and the image display program may direct the display to play back the image data stored in the hard disk.

In an embodiment of the present invention, the above-described data storage unit further includes an expansion slot and an external memory card, wherein the expansion slot is disposed on the body and the external memory card is plugged in the expansion slot for storing the image data captured by the first lens and/or the second lens or image data stored in the hard disk.

In an embodiment of the present invention, the above-described the above-described data storage unit further includes a transmission slot and a cassette magnetic disk, wherein the transmission slot is disposed on the body and the cassette magnetic disk is plugged in the transmission slot for storing the image data captured by the first lens and/or the second lens or image data stored in the hard disk.

In an embodiment of the present invention, the above-described driving module with bidirectional lenses and screen for displaying images further includes a prompt unit disposed in the body.

In an embodiment of the present invention, the above-described prompt unit may include a GPS (global positioning system).

In an embodiment of the present invention, the above-described prompt unit may include a speed measuring radar.

In an embodiment of the present invention, the above-described speed measuring radar may further include a button disposed and exposed on the body, and may be adopted for turning on or turning off the speed measuring radar.

Since the driving module with bidirectional lenses and screen for displaying images of the present invention uses an image capturing unit and an image displaying unit, thus, it enables to perform video recording on the front and back, the left and right and other direction around the vehicle and on the vehicle interior, and playing back the captured images. Besides, the images captured by the image capturing unit can be stored in the data storage unit and can be transmitted for sharing it with other multimedia devices. The driving module with bidirectional lenses and screen for displaying images of the present invention may be integrated with many accessories for use and may be disposed on the windshield in front interior of the vehicle, and therefore a driver may monitor the whole running conditions of the vehicle while driving without being distracted from the driving view field. Therefore, the driver may be able to keep attention on driving and meanwhile operate manipulate all accessories integrated to the driving module. In this way, the safety of the driving may be effectively promoted.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve for explaining the principles of the invention.

FIG. 1A is a sectional view of a vehicle front interior.

FIG. 1B is a sectional view showing a vehicle front interior where the driving module with bidirectional lens and screen for displaying image is shrunk back in the dashboard thereof.

FIG. 2A is a schematic front view of a driving module with bidirectional lens and screen for displaying image according to an embodiment of the present invention.

FIG. 2B is a schematic top view of a driving module with bidirectional lens and screen for displaying image according to an embodiment of the present invention.

FIG. 2C is a schematic bottom view of a driving module with bidirectional lens and screen for displaying image according to an embodiment of the present invention.

FIG. 3A is a schematic view of a multiple-directions rotatable lens of the present invention and FIG. 3B is a operation diagram of a multiple-directions rotatable lens in the FIG. 3A.

FIG. 4 is a block diagram showing the configuration of a driving module with bidirectional lens and screen for displaying image according to an embodiment of the present invention.

### DESCRIPTION OF THE EMBODIMENTS

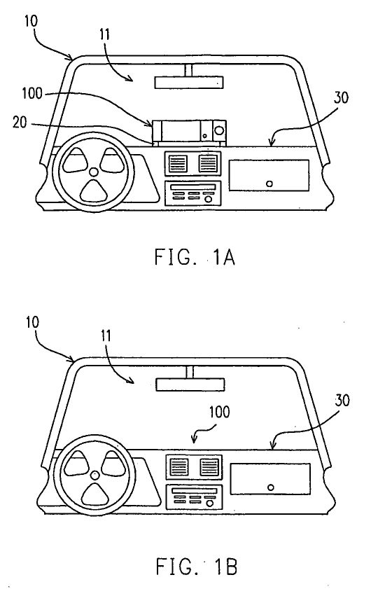

FIG. 1A is a sectional view of a vehicle front interior. Referring to FIG. 1A, the driving module with bidirectional lenses and screen for displaying images 100 according to an embodiment of the present invention may be disposed inside an interior of a vehicle 10 for a driver to monitor the scene behind the driver. The driving module 10 may be equipped with a pivoted base for adjusting the position thereof at an appropriate position, for example, on the dashboard 30 of the vehicle close to the windshield 11. The base 20 may have two or more freedom movement so that the driver can adjust the orientation and position of the driving module with bidirectional lenses and screen for displaying images 100.

The driver can, according to the personal need, may adjust the position of the base 20 to adjust the driving module with bidirectional lenses and screen for displaying images 100 in a desired position orientation. Besides, if the driver does not need the driving module with bidirectional lenses and screen for displaying images 100, the base 20 with the pivoted driving module 100 can be shrunk back into the dashboard 30 (as shown in FIG. 1B). Alternatively, the driving module with bidirectional lenses and screen for displaying images 100 certainly may be disposed on the roof of the vehicle interior.

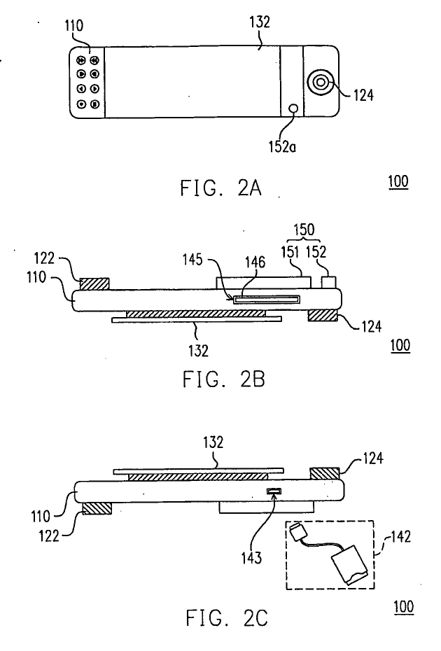

FIG. 2A is a schematic front view of a driving module with bidirectional lens and screen for displaying image of the present invention and FIG. 2B is a schematic top view of a driving module with bidirectional lens and screen for displaying image of the present invention. Referring to FIGS. 2A and 2B, the driving module with bidirectional lenses and screen for displaying images 100 includes a body 110, an image capturing unit 120 (only the partial portion thereof, i.e. a first lens 122 and a second lens 124 are exposed on the body 110 in FIGS. 2A and 2B) and an image displaying unit 130 (only the partial portion thereof, i.e. a display 132 is exposed on the body 110 in FIGS. 2A and 2B).

Note that the image capturing unit 120 of the present invention, except for the first lens 122 and the second lens 124 thereof, is disposed inside the body 110, wherein the allocation thereof can be accommodated inside the body 110 without any specific space requirement. The first and second lenses 122 and 124 of the image capturing unit are adopted for capturing the front scene, the rear scene and the backseat of the vehicle, or the left scene and the right scene of the vehicle. The static images or the dynamic images can be recorded in digital format or in any other recording modes.

The image capturing unit first lens 122 and the second lens 124 of the image capturing unit 120 are disposed and exposed on the body 110 and may be comprised of a common CCDs (charge-coupled devices). Wherein, the first lens 122 is adopted for capturing images from the first direction (for example, vehicle's front direction) and the second lens 124 is adopted for capturing images from the second direction (for example, vehicle's rear direction including the backseat).

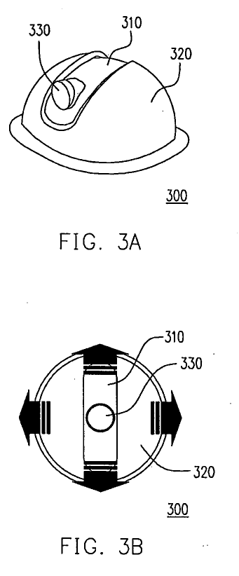

FIG. 3A is a schematic view of a multiple-directions rotatable lens of the present invention and FIG. 3B is a operation diagram of a multiple-directions rotatable lens in the FIG. 3A. The multiple-directions rotatable lens 300 includes a first rotatable seat 310 and a second rotatable seat 320, and a lens 330 is disposed on the first rotatable seat 310. The first and second rotatable seats 310 and 320 are adopted for rotating the lens 330 along a vertical visual angle and a horizontal visual angle respectively so that the lens 330 may capture image in any vertical or horizontal visual angle by employing the first and second rotatable seats 310 and 320 as shown in FIG. 3B. Thus, the multiple-directions rotatable lens 300 is not only employed for capturing images from a single direction but may also be employed for capturing images in a full range of visual angles, such as an eye. A user may, manually or via electrical control, adjust the direction of the lens 330 such as up, down, left or right for better performance according to different requirements.

When passengers at the backseat hold a business meeting or have an important agenda, all these events may be captured by the second lens 124 of the image capturing unit 120 as backup data. Besides, a taxi driver may be also use the second lens 124 of the image capturing unit 120 to capture the face and the behavior of a customer; if there is a dispute between the taxi driver and the customer, the image data captured by the second lens 124 of the image capturing unit 120 can be used as an evidence to settle the matter.

On the other hand, since the whole situation around/inside the vehicle can be recorded by the image capturing unit 120, during an event of a traffic accident, the images recorded by the image capturing unit 120 can be used as an evidence to understand the cause of the traffic accident. Similarly, if an accident occurs with a front vehicle or a rear vehicle, the images recorded by the image capturing unit 120 can be used as an evidence to assist police for investigation.

The images or video recorded by the lenses 122 and 124 of the image capturing unit 120 can be either immediately played back in the vehicle by using the display 132 of the image displaying unit 130 of the present invention or stored for later use (as described hereinafter). The image displaying unit 130 is disposed in the body 110 and the display 132 may be comprised of, for example, a LCD (liquid crystal display), an OLED (organic light emitting display) or any other displays for playing back images. The major function of the display 132 is for playing back the images recorded by the first and second lenses 122 and 124 of the image capturing unit 130 and also for playing back entertainment images or video in association with other multimedia devices.

The display 132 may be adopted for separately displaying the images captured by the first lens 122 or the images captured by the second lens 124, or for simultaneously displaying the images captured by the first lens 122 and the second lens 124 in a multiple viewing mode. The display 132 has multi functions, for example, slow motion playback, frame advance playback, fast forward/rewind or search for searching a specific desired section.

The driving module with bidirectional lenses and screen for displaying images 100 of the present invention is described above, hereinafter, the use of the driving module associated with other integrated electronic devices will be described.

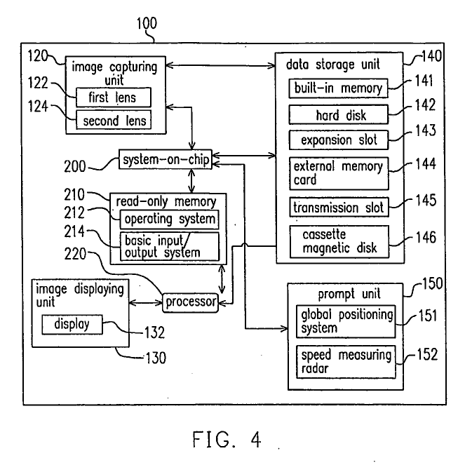

FIG. 4 is a block diagram showing the configuration of a driving module with bidirectional lens and screen for displaying image of the present invention. Referring to FIG. 3, to store the images captured by the image capturing unit 120, the driving module with bidirectional lenses and screen for displaying images 100 of the present invention further includes a data storage unit 140, which may be assembled with the body 110 and may comprise a built-in memory 141 and a hard disk 142.

The built-in memory 141 may be adopted for storing an image capturing program and/or an image displaying program. The image capturing program may direct the first lens 122 and/or the second lens 124 to capture images and store the captured images into the hard disk 142 and the image displaying program may direct the display 132 to play back the image data stored in the hard disk 142 in different playback modes depending on the user's requirements. A driver can, at his diskretion, separately or simultaneously display (in multiple viewing mode) the images captured by the first lens 122 and the second lens 124, so as to monitor the circumstances around the vehicle 10.

The above-described operation may be controlled by a ‘system on a chip’ (SoC) 200 or other applicable chips. For example, the image data recorded by the image capturing unit 120 may be directly stored into the hard disk 142 of the data storage unit 140, and then through the SoC 200 and a software stored in a read-only memory (ROM) 210 and comprised of an operating system (OS) 212 and a basic input/output system (BIOS) 214 can control the image capturing program stored in the built-in memory 141 for directing the first lens 122 and/or the second lens 124 of the image capturing unit 120 and store the images into the hard disk 142.

The SoC 200 and the software stored in a read-only memory (ROM) 210 may also adopted for directing a processor 220 to decode the image data stored in the data storage unit 140, and then the image displaying program in the data storage unit 140 is uploaded to direct the image displaying unit 130 for playing back images.

FIG. 2C is a schematic bottom view of a driving module with bidirectional lens and screen for displaying image of the present invention. Referring to FIG. 2C, to transmit the images recorded by the image capturing unit 120 to other external multimedia devices, for example a desktop computer or a notebook computer for sharing, the data storage unit 140 of the present invention further includes an expansion slot 143 and an external memory card 144. Wherein, the expansion slot 143 is disposed on the body 110, preferably for example, at the upper edge or the lower edge of the body 110.

The expansion slot 143 may be comprised of, for example, a universal serial bus (USB), and the external memory card 144 may be plugged into the expansion slot 143 for storing the image data captured by the first lens 122 and/or the second lens 124 or the image data stored in the hard disk.

The format of the image data stored in the hard disk 142 may be in JPEG format (standing for Joint Photographic Experts Group, a commonly used standard method of lossy compression for photographic images), AVI format (standing for Audio Video Interleave, the most common format for audio/video data on the PC) or other usual formats. In this way, a user may be able to re-store the image data of the hard disk 142 into the external memory card 144 for portable use or sharing it with other multimedia devices.

The method for storing images can be various, for example, the data storage unit 140 of the present invention may further include a transmission slot 145 and a cassette magnetic disk 146 (as shown in FIG. 2B). Wherein, the transmission slot 145 is disposed on the body 110, while the cassette magnetic disk 146 is plugged in the transmission slot 145 for storing the image data caught by the first lens 122 and/or the second lens 124 or image data that is already stored in the hard disk 142. By means of the cassette magnetic disk 146, a user can carry the image data for portable use or sharing it with other multimedia devices.

To meet the stringent vehicle emission inspection standard of today, a vehicle is usually equipped with an ‘on-board diagnostics system’ (OBD), which connects all sensors in the vehicle for inspecting the components related to vehicle emission, for example, the fuel device or the EGR (exhaust gas recirculation system). Once the exhausted waste gas exceeds the control standard, the alert light on the instrument panel would lighten and the related problem sources are pinpointed. The above-described inspection data can also be transmitted to external multimedia devices through a diagnostics link connector (DLC) disposed in the vehicle.

The data storage unit 140 of the present invention may be electrically connected to the DLC for storing the above-described vehicle diagnostic data therein. In addition, the vehicle diagnostic data can image displaying unit be displayed on the display 132 through the image displaying unit 130 so that the driver or a maintenance technician is able to quickly learn the condition of the vehicle. Certainly, the OBD may also provide other detail information such as information regarding catalytic converter, misfire monitoring, evaporation control system (ECS), fuel system or memorized computer code information. Wherein, the above-described memorized computer code information includes the information, for example, steering, accelerating, braking, shifting, turning on ‘turn signal light’ or starting up wiper information, and the like. All such information may be stored in the data storage unit 140 and can be used for future review.

The driving module with bidirectional lenses and screen for displaying images 100 of the present invention is able to integrate many accessories for use, which does not require a driver to divert the attention from the driving view field to operate/view all accessories integrated to the driving module 100. In this way, the safety of the driving may be effectively promoted.

The driving module with bidirectional lenses and screen for displaying images 100 of the present invention can further include a prompt unit 150 combined with the body 110. The prompt unit 150 uses sound and light to prompt a driver and includes a GPS 151 (global positioning system) for providing a driver with a driving road map on the display 132. Usually, the GPS 151 has a smart voice-prompt function, smart turn-by-turn navigation indications, automatic route plann and a detail electronic map. The above-described data can be stored in the data storage unit 140 and be periodically updated by a built-in map updating program.

The above-described prompt unit 150 can also include a speed measuring radar 152 disposed at the same side as the first lens 122 for better receiving signals. The speed measuring radar 152 further includes a button 152a disposed and exposed on the body 110 for the driver to conveniently turn on or turn off the speed measuring radar 152. Usually, the speed measuring radar 152 has a voice-prompted speed alert function to remind the driver to keep within a safe driving speed.

In summary, the driving module with bidirectional lenses and screen for displaying images of the present invention has at least the following advantages:

1. Since the driving module with bidirectional lenses and screen for displaying images of the present invention employs an image capturing unit for recording the scene images in front of or behind the vehicle and of the vehicle interior, and the recorded images can be played back using an image displaying unit. Therefore, the meeting held by passengers in the vehicle or the outside situation surrounding the vehicle can be recorded for reference later.

2. The driving module with bidirectional lenses and screen for displaying images of the present invention can integrate a plurality of accessories for use. The driving module can be disposed at the windshield of the vehicle or at other appropriate places where a driver need not divert the focus from the driving view field to operate/view all accessories integrated to the driving module. In this way, the safety of the driving can be effectively promoted.

3. The image data captured by the image capturing unit of the present invention can be stored in a data storage unit, and then stored into an external memory card or a cassette magnetic disk for portable use or for sharing it with other multimedia to play back.

It will be apparent to those skilled in the art that various modifications and variations can be made to the structure of the present invention without departing from the scope or spirit of the invention. In view of the foregoing, it is intended that the specification and examples to be considered as exemplary only, with a true scope and spirit of the invention being indicated by the following claims and their equivalents.

1. A driving module with bidirectional lenses and screen for displaying images, comprising:
a body, disposed in a vehicle;
an image capturing unit, disposed in the body and having a first lens and a second lens both disposed and exposed on the body, wherein the first lens is adopted for capturing images from a first direction and the second lens is adopted for capturing images from a second direction; and
an image displaying unit, disposed in the body and having a display, wherein the display is adopted for playing back the images captured by the first lens and/or second lens.

2. The driving module with bidirectional lenses and screen for displaying images as recited in claim 1, further comprising a data storage unit disposed in the body, wherein the data storage unit comprises a built-in memory and a hard disk, the built-in memory is adopted for storing an image capturing program and/or an image displaying program, wherein the image capturing program directs the first lens and/or the second lens to capture images, and wherein the images is stored in the hard disk, and the image displaying program directs playing back of the image data stored in the hard disk.

3. The driving module with bidirectional lenses and screen for displaying images as recited in claim 2, wherein the data storage unit further comprises an expansion slot and an external memory card, the expansion slot is disposed on the body and the external memory card is plugged in the expansion slot for storing the image data captured by the first lens and/or the second lens or for storing the image data stored in the hard disk.

4. The driving module with bidirectional lenses and screen for displaying images as recited in claim 2, wherein the data storage unit further comprises a transmission slot and a cassette magnetic disk, the transmission slot is disposed on the body, while the cassette magnetic disk is plugged in the transmission slot for storing the image data captured by the first lens and/or the second lens or for storing the image data stored in the hard disk.

5. The driving module with bidirectional lenses and screen for displaying images as recited in claim 1, further comprising a prompt unit disposed in the body.

6. The driving module with bidirectional lenses and screen for displaying images as recited in claim 5, wherein the prompt unit comprises a global positioning system (GPS).

7. The driving module with bidirectional lenses and screen for displaying images as recited in claim 5, wherein the prompt unit comprises a speed measuring radar.

8. The driving module with bidirectional lenses and screen for displaying images as recited in claim 7, wherein the speed measuring radar further comprises a button, disposed and exposed on the body for turning on or turning off the speed measuring radar.

9. The driving module with bidirectional lenses and screen for displaying images as recited in claim 1, wherein the first lens is a multiple-direction rotatable lens.

10. The driving module with bidirectional lenses and screen for displaying images as recited in claim 9, wherein the multiple-directions rotatable lens comprises a first rotatable seat and a second rotatable seat, and the first lens disposed on the first rotatable seat is adopted for capturing images from a first visual angle of the first direction rotated by the first rotatable seat, and the first lens and the first rotatable seat disposed on the second rotatable seat is adopted for capturing images from a second visual angle of the first direction rotated by the second rotatable seat.

11. The driving module with bidirectional lenses and screen for displaying images as recited in claim 1, wherein the second lens is a multiple-directions rotatable lens.

12. The driving module with bidirectional lenses and screen for displaying images as recited in claim 11, wherein the multiple-direction rotatable lens comprises a first rotatable seat and a second rotatable seat, and the second lens disposed on the first rotatable seat is adopted for capturing images from a first visual angle of the second direction rotated by the first rotatable seat, and the second lens and the first rotatable seat disposed on the second rotatable seat is adopted for capturing images from a second visual angle of the second direction rotated by the second rotatable seat.
